(19) United States
(12) Patent Application Publication
(10) Pub. No.: US 2026/0135044 A1
(43) Pub. Date: May 14, 2026

(54) SUPERCAPACITOR ELECTRODE COATING MATERIALS INCLUDING ACTIVE COMPOSITE PARTICLES AND CONDUCTIVE CARBON-CONTAINING PARTICLES

(71) Applicant: PPG Industries Ohio, Inc., Cleveland, OH (US)

(72) Inventors: Samuel Logan Esarey, Allison Park, PA (US); Michael John Pawlik, Glenshaw, PA (US); Larry John Ruffaner, Ellwood City, PA (US); Cynthia Kutchko, Pittsburgh, PA (US); Caitlyn Beth Mahaffey, Gibsonia, PA (US); Scott William Sisco, Glenshaw, PA (US); John Leonard DiMeglio, Pittsburgh, PA (US); Adam Jacob Crowe, Chesterfield, MI (US)

(73) Assignee: PPG Industries Ohio, Inc., Cleveland, OH (US)

(21) Appl. No.: 19/119,175

(22) PCT Filed: Aug. 10, 2023
(86) PCT No.: PCT/US2023/071982

§ 371 Date: Apr. 8, 2025

Related U.S. Application Data
(60) Provisional application No. 63/378,886, filed on Oct. 10, 2022.

(51) Int. Cl. H01G 11/46; C01B 32/194; C01G 45/024; H01G 11/24; H01G 11/26; H01G 11/34; H01G 11/36; H01G 11/38; H01G 11/42; H01G 11/86

(52) U.S. Cl. CPC H01G 11/46; C01B 32/194; C01G 45/024; H01G 11/24; H01G 11/26; H01G 11/34; H01G 11/36; H01G 11/38; H01G 11/42; H01G 11/86; C01B 2204/22; C01P 2004/03; C01P 2004/61; C01P 2004/62; C01P 2004/84; C01P 2006/22; C01P 2006/40

(57) ABSTRACT

A coating for use as a supercapacitor electrode is disclosed. The coating comprises active composite particles including activated metal oxide particles and carbon-containing support particles, and conductive carbon-containing particles.

### CROSS-REFERENCE TO RELATED APPLICATION

This application claims the benefit of U.S. Provisional Patent Application No. 63/378,886 filed Oct. 10, 2022, which is incorporated herein by reference.

### GOVERNMENT CONTRACT

This disclosure was made with Government support under Government Contract No. 2021039-142041 awarded by the United States Army Ground Vehicle Systems Center. The United States Government has certain rights in this disclosure.

### FIELD

Coatings for use in supercapacitor electrodes including active composite particles and conductive carbon-containing particles are disclosed.

### BACKGROUND

A large demand exists for high-power energy resources for use in various products such as portable electronic devices and electric vehicles. Supercapacitors offer a promising alternative to conventional capacitors and can replace, or be used in combination with, batteries for such uses. Compared with conventional capacitors, the specific energy of supercapacitors can be several orders of magnitude higher. In addition, supercapacitors are able to store energy and deliver power at relatively high rates beyond those accessible with batteries.

### SUMMARY

Disclosed herein is a coating for use as a supercapacitor electrode. The coating comprises active composite particles comprising activated metal oxide particles and carbon-containing support particles, and conductive carbon-containing particles.

Disclosed herein are active composite particles for use in supercapacitor electrode coatings. The active composite particles comprise activated metal oxide particles, and carbon-containing support particles.

Disclosed herein is a method of making active composite particles for use in supercapacitor electrode coatings. The method comprises spray drying an aqueous solution comprising activated metal oxide particles and carbon-containing support particles and recovering the active composite particles comprising the activated metal oxide particles and the carbon-containing support particles.

Disclosed herein is a supercapacitor electrode comprising a current collector substrate, and an electrode coating comprising active composite particles comprising activated metal oxide particles and carbon-containing support particles, and conductive carbon-containing particles.

### BRIEF DESCRIPTION OF THE DRAWINGS

FIG. 1 includes rheological profiles of various aqueous graphene dispersions.

FIG. 2 includes viscosity measurements of aqueous dispersions containing various quantities of graphene.

FIG. 3 includes instability indexes of various aqueous graphene dispersions.

FIG. 4 includes rheological data for dispersions containing MnO₂, graphene, conductive carbon and binder.

FIG. 5 is a cross-sectional scanning electron microscope image of MnO₂+GNP cathode coating on a carbon-coated Ni foil.

FIG. 6 is a cross-sectional scanning electron microscope electron dispersive spectroscopy (SEM-EDS) mapping of a MnO₂+GNP cathode coating on carbon-coated Ni foil.

FIG. 7 is a cross-sectional scanning electron microscope image of MnO₂|GNP cathode coating on a carbon-coated Ni foil.

FIG. 8 is a cross-sectional scanning electron microscope electron dispersive spectroscopy (SEM-EDS) mapping of a MnO₂|GNP cathode coating on carbon-coated Ni foil.

FIG. 9 is a cross-sectional scanning electron microscope image of a spray-dried MnO₂|GNP cathode coating on a carbon-coated Ni foil.

FIG. 10 is a cross-sectional scanning electron microscope electron dispersive spectroscopy (SEM-EDS) mapping of a spray-dried MnO₂|GNP cathode coating on carbon-coated Ni foil.

FIG. 11 includes capacitance vs current density (j) plots for electrodes with 80/10/10 active/carbon black/binder coatings.

FIG. 12 includes capacitance vs current density (j) plots for electrodes with 88/2/10 active/carbon black/binder coatings.

FIG. 13 includes capacitance vs current density (j) plots for electrodes with 80/10/10 active/carbon black/binder coatings.

FIG. 14 includes capacitance vs current density (j) plots for electrodes with 80/10/10 active/carbon black/binder coatings.

FIG. 15 includes cyclic voltammetry of full cells using 80/10/10 active/carbon black/binder electrode compositions.

FIG. 16 includes capacitance vs current density (j) plots for electrodes with 80/10/10 active/carbon black/binder coatings.

FIG. 17 includes composite and interfacial resistivity measurements of supercapacitor cathode coatings on foil with 88/2/10 active/carbon black/binder formulations.

### DETAILED DESCRIPTION

Supercapacitor electrode coatings comprise active composite particles and conductive carbon-containing particles. The supercapacitor electrode coatings may also include a binder. The active composite particles may include activated metal oxide particles and graphenic carbon nanoparticles. As used herein, the term “activated”, when referring to the metal oxide particles, means the materials are subjected to physical, thermal and/or chemical processes to store ionic charge and/or produce an electrochemical interaction or reaction with other components during use.

The electrode coatings may be used in various types of supercapacitors including asymmetric supercapacitors, symmetric supercapacitors, Li-ion capacitors, Na-ion capacitors and the like. For example, as known to those skilled in the art, an asymmetric supercapacitor or asymmetric pseudo-capacitor comprises two electrodes, namely a cathode and anode, of differing materials separated by an ionically conductive, electrically insulating electrolyte and separator contained within a cell. The electrodes of different composition store electrical energy through the adsorption of oppositely charged ions onto their respective surfaces.

The electrode coatings may be used to produce supercapacitor cathodes and/or supercapacitor anodes. While supercapacitor cathodes are primarily described herein, it is to be understood that the present supercapacitor coatings may also be used as supercapacitor anodes.

The supercapacitor electrode coatings may typically include at least 50 weight percent of the active composite particles, or at least 60 weight percent, or at least 70 weight percent, based on the total weight of the coating. The supercapacitor electrode coatings may typically include up to 99 weight percent of the active composite particles, or up to 98 weight percent, or up to 95 weight percent. The supercapacitor electrode coatings may typically include from 50 to 99 weight percent of the active composite particles, for example, from 60 to 98 weight percent, or from 70 to 95 weight percent.

The supercapacitor electrode coatings may typically include at least 0.5 weight percent of the conductive carbon-containing particles, or at least 1 weight percent, or at least 2 weight percent, or at least 4 weight percent, or at least 5 weight percent, or at least 8 weight percent based on the total weight of the coating. The supercapacitor electrode coatings may typically include up to 50 weight percent of the conductive carbon-containing particles, or up to 30 weight percent, or up to 20 weight percent, or up to 15 weight percent, or up to 12 weight percent. The supercapacitor electrode coatings may typically include from 0.5 to 50 weight percent conductive carbon-containing particles, for example, from 1 to 30 weight percent, or from 2 to 20 weight percent, or from 5 to 15 weight percent, or from 8 to 12 weight percent. The conductive carbon-containing particles may comprise carbon black, graphite.

The supercapacitor electrode coatings may typically include a binder, for example, at least 0.01 weight percent binder, or at least 0.1 weight percent, or at least 1 weight percent, or at least 2 weight percent based on the total weight of the coating. The supercapacitor electrode coatings may typically include up to 20 weight percent binder, or up to 15 weight percent, or up to 10 weight percent. The supercapacitor electrode coatings may typically include from 0 to 20 weight percent binder, for example, from 1 to 15 weight percent, or from 2 to 10 weight percent.

The active composite particles may typically comprise at least 1 weight percent activated metal oxide particles, for example, at least 50 weight percent, or at least 70 weight percent. The active composite particles may comprise up to 99 weight percent activated metal oxide particles, for example, up to 95 weight percent, or up to 90 weight percent.

The active composite particles may typically comprise at least 1 weight percent carbon-containing support particles, for example, at least 5 weight percent, or at least 10 weight percent. The active composite particles may comprise up to 99 weight percent carbon-containing support particles, for example, up to 50 weight percent, or up to 30 weight percent.

The active composite particles may typically comprise from 1 to 99 weight percent activated metal oxide particles and from 1 to 99 weight percent carbon-containing support particles, for example, from 50 to 95 weight percent activated metal oxide particles and from 5 to 50 weight percent carbon-containing support particles, or from 70 to 90 weight percent activated metal oxide and from 10 to 30 weight percent carbon-containing support particles.

The active composite particles may include a composite binder that may help bind the activated metal oxide particles and graphenic carbon nanoparticles together and/or help bind particles comprising activated metal particles grown or deposited on graphenic carbon nanoparticles together. Suitable composite binders include polyacrylic acid, polyvinyl pyrrolidone, poly(maleic acid), poly(4-styrenesulfonic acid) sodium salt, poly(4-styrenesulfonic acid-co-maleic acid) sodium salt and the like. The composite binder may also be cross-linked with a carbodiimide crosslinker such as Carbodilite V-02-L2 or melamine. The composite binder may comprise from zero to 10 weight percent of the active composite particles, or from 0.01 to 5 weight percent, or from 0.1 to 2 weight percent.

There may be from 0 to 5 or 10 weight percent dispersant in the active composite particles and/or in a powder comprising the active composite particles. For example, suitable dispersants in the active composite particles, or mixed therewith, may include polyacrylic acid, polyvinyl pyrrolidone, poly(maleic acid), poly(4-styrenesulfonic acid) sodium salt, poly(4-styrenesulfonic acid-co-maleic acid) sodium salt and the like. For example, the dispersant may be an acrylic polymer containing acrylic acid that is neutralized using sodium hydroxide or potassium hydroxide. The dispersant may also be cross-linked with a carbodiiride crosslinker such as Carbodilite V-02-L2.

The active composite particles may have an average particle size, as measured by a standard scanning electron microscope (SEM) test, from 100 nanometers to 100 microns, or from 1 to 20 microns, or from 2 to 10 microns. The composite particles may be dispersed on segments of carbon tape attached to aluminum stubs and coated with Au/Pd for 20 seconds. Samples may then be analyzed in a Quanta 250 FEG SEM under high vacuum. The accelerating voltage may be set to 20.00 kV and the spot size may be 3.0. Thirty particles may be measured from three different areas to provide an average particle size for each sample.

The activated metal oxide particles may comprise manganese oxide, potassium manganese oxide, sodium manganese oxide, lithium manganese oxide, nickel manganese oxide, iron manganese oxide, ruthenium oxide, cobalt oxide, manganese cobalt oxide, iron oxide, nickel oxide, nickel hydroxide, titanium oxide, iron cobalt oxide, vanadium oxide and the like. When the activated metal oxide is manganese oxide, it may be provided as stoichiometric MnO₂, or as sub-stoichiometric or super-stoichiometric manganese oxide. The manganese oxide may be activated by the inclusion of alkaline cations and water within the structure such that the chemical structure could be described as AₓMnO_{y}•nH₂O, where “A” is an alkali metal such as lithium, sodium, or potassium, “x” is the number of alkali metals within the reduced chemical formula, “y” is the number of oxygens contained within the metal oxide structure where y is typically less than or equal to 2, and “n” is the number of water molecules within the reduced chemical structure of the activated metal oxide. The manganese oxide may be further activated by the reduction of the oxidation state from 7+ to 4+, 3+, 2+, or neutral through means of electrochemical reduction by an applied voltage or through a chemical reducing agent such as ethanol, isopropanol, ethylene glycol, benzyl alcohol, 2-pyridinemethanol, furfuryl alcohol. poly(ethylene glycol), sodium thiosulfate, manganese(II) acetate, manganese(II) chloride, manganese(II) sulfate, and the like. The other metal oxides described above may be activated in a similar manner.

The carbon-containing support particles of the active composite particles may provide an electrically conductive support structure upon which the activated metal oxide particles may be grown or deposited. As used herein, the term “grown on”, when referring to the activated metal oxide particles and the carbon-containing support particles, means that the activated metal oxide particles are deposited on pre-formed carbon-containing support particles, including being deposited directly on the surfaces of such carbon-containing support particles, deposited on other activated metal oxide particles previously deposited on the carbon-containing support particles, grown within solution in the presence of the carbon-containing support particles, and combinations thereof. Thus, physical and/or chemical interaction between the activated metal oxide particles and the carbon-containing support particles may occur. For example, the activated metal oxide particles may be grown or deposited on the carbon-containing support particles before or during a spray drying process in which an aqueous solution or slurry containing the particles is spray dried, as more fully described below. The carbon-containing support particles may comprise graphenic carbon nanoparticles, such as thermally produced graphenic carbon nanoparticles, exfoliated graphite graphene nanoparticles, carbon nanotubes, reduced graphene oxide, graphene oxide, fullerenes and the like.

The carbon-containing support particles may comprise activated carbon, which may be used in place of, or in addition to, the graphenic carbon nanoparticles. The activated carbon support particles may be activated by thermal heat treatment, exposure to a reactive metal oxide precursor material such as potassium permanganate, manganese acetate, nickel acetate, nickel acetylacetonate, iron acetate, iron acetylacetonate, cobalt acetate, cobalt acetylacetonate, titanium chloride, titanium oxysulfate, vanadium chloride, vanadium oxychloride, vanadium acetylacetonate, ruthenium chloride, (1,5-cyclooctadiene) ruthenium chloride, ruthenium acetylacetonate and the like. The activated carbon support particles may also be activated through the use of alkaline hydroxide salts such as lithium hydroxide, sodium hydroxide, potassium hydroxide, cesium hydroxide, or the like.

When the carbon-containing support particles comprise graphenic carbon nanoparticles, such nanoparticles may comprise exfoliated graphite graphene, which may be obtained from commercial sources, for example, from Angstron, XG Sciences and other commercial sources.

Thermally graphenic carbon nanoparticles may be thermally produced in accordance with the methods and apparatus described in U.S. Pat. Nos. 8,486,363, 8,486,364 and 9,221,688, which are incorporated herein by reference. Such thermally produced graphenic carbon nanoparticles may be commercially available from Raymor. Other carbon-containing materials such as activated carbon may be used in combination with, or in place of, the graphenic carbon nanoparticles.

As used herein, the term “graphenic carbon particles” means carbon particles having structures comprising one or more layers of one-atom-thick planar sheets of sp²-bonded carbon atoms that are densely packed in a honeycomb crystal lattice. The average number of stacked layers may be less than 100, for example, less than 50. The average number of stacked layers may be 30 or less, such as 20 or less, 10 or less, or, in some cases, 5 or less. The average number of stacked layers may be greater than 2, for example, greater than 3, or greater than 4. At least a portion of the graphenic carbon particles may be in the form of platelets that are substantially curved, curled, creased or buckled. The graphenic carbon nanoparticles may be turbostatic, i.e., adjacent stacked atom layers do not exhibit ordered AB Bernal stacking associated with conventional exfoliated graphene, but rather exhibit disordered or non-ABABAB stacking. Alternatively, the graphenic carbon particles may be in the form of nanotubes. The particles typically do not have a spheroidal or equiaxed morphology.

The graphenic carbon nanoparticles may have a thickness, measured in a direction perpendicular to the carbon atom layers, of no more than 10 nanometers, no more than 5 nanometers, or, no more than 4 or 3 or 2 or 1 nanometers, such as no more than 3.6 nanometers. The graphenic carbon particles may be from 1 atom layer up to 3, 6, 9, 12, 20 or 30 atom layers thick, or more. The graphenic carbon particles present in the compositions may have a width and length, measured in a direction parallel to the carbon atoms layers, of at least 50 nanometers, such as more than 100 nanometers, in some cases more than 100 nanometers up to 500 nanometers, or more than 100 nanometers up to 200 nanometers. The graphenic carbon particles may be provided in the form of ultrathin flakes, platelets or sheets having relatively high aspect ratios (aspect ratio being defined as the ratio of the longest dimension of a particle to the shortest dimension of the particle) of greater than 3:1, such as greater than 10:1. Alternatively, when the graphenic carbon particles are in the form of nanotubes, they may have outer diameters ranging from 0.3 to 100 nanometers, or from 0.4 to 40 nanometers, lengths ranging from 0.3 nanometers to 50 centimeters, or from 500 nanometers to 500 microns, and length:diameter aspect ratios ranging from 1:1 to 100,000,000:1, or from 10:1 to 10,000:1.

The graphenic carbon particles may have relatively low oxygen content. For example, the graphenic carbon particles may, even when having a thickness of no more than 5 or no more than 2 nanometers, have an oxygen content of no more than 2 atomic weight percent, such as no more than 1.5 or 1 atomic weight percent, or no more than 0.6 atomic weight, such as about 0.5 atomic weight percent. The oxygen content of the graphenic carbon particles can be determined using X-ray Photoelectron Spectroscopy, such as is described in D. R. Dreyer et al., Chem. Soc. Rev. 39, 228-240 (2010).

The graphenic carbon particles may have a B.E.T. specific surface area of at least 50 square meters per gram, such as 70 to 1000 square meters per gram, or, in some cases, 200 to 1000 square meters per gram or 200 to 400 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

The graphenic carbon particles may have a Raman spectroscopy 2D/G peak ratio of at least 0.9:1, or 0.95:1, or 1:1, for example, at least 1.2:1 or 1.3:1. As used herein, the term “2D/G peak ratio” refers to the ratio of the intensity of the 2D peak at 2692 cm⁻¹ to the intensity of the G peak at 1,580 cm⁻¹. Such 2D/G peak ratios may be present in graphenic carbon nanoparticles having an average number of stacked layers greater than 2, such as 3 or more stacked layers.

The graphenic carbon particles may have a relatively low bulk density. For example, the graphenic carbon particles may be characterized by having a bulk density (tap density) of less than 0.2 g/cm³, such as no more than 0.1 g/cm³. The bulk density of the milled graphenic carbon particles may be determined by placing 0.4 grams of the graphenic carbon particles in a glass measuring cylinder having a readable scale. The cylinder is raised approximately one inch and tapped 100 times, by striking the base of the cylinder onto a hard surface, to allow the graphenic carbon particles to settle within the cylinder. The volume of the particles is then measured, and the bulk density is calculated by dividing 0.4 grams by the measured volume, wherein the bulk density is expressed in terms of g/cm³.

The graphenic carbon particles may have a compressed density and a percent densification that is less than the compressed density and percent densification of graphite powder and certain types of substantially flat graphenic carbon particles. Lower compressed density and lower percent densification are each currently believed to contribute to better dispersion and/or rheological properties than graphenic carbon particles exhibiting higher compressed density and higher percent densification. The compressed density of the graphenic carbon particles may be 0.9 or less, such as less than 0.8. less than 0.7, such as from 0.6 to 0.7. The percent densification of the graphenic carbon particles may be less than 40%, such as less than 30%, such as from 25 to 30%.

The compressed density of graphenic carbon particles may be calculated from a measured thickness of a given mass of the particles after compression. Specifically, the measured thickness is determined by subjecting 0.1 grams of the graphenic carbon particles to cold press under 15,000 pound of force in a 1.3 centimeter die for 45 minutes, wherein the contact pressure is 500 MPa. The compressed density of the graphenic carbon particles is then calculated from this measured thickness according to the following equation:

$$Compressed Density ( g / {cm}^{3} ) = \frac{0.1 grams}{Π * {( 1.3 cm / 2 )}^{2} * ( measured thickness in cm )}$$

The percent densification of the graphenic carbon particles is then determined as the ratio of the calculated compressed density of the graphenic carbon particles, as determined above, to 2.2 g/cm³, which is the density of graphite.

The graphenic carbon particles may have a measured bulk liquid conductivity of at least 100 microSiemens, such as at least 120 microSiemens, such as at least 140 microSiemens immediately after mixing and at later points in time, such as at 10 minutes, or 20 minutes, or 30 minutes, or 40 minutes. The bulk liquid conductivity of the graphenic carbon particles may be determined as follows. First, a sample comprising a 0.5% solution of graphenic carbon particles in butyl cellosolve is sonicated for 30 minutes with a bath sonicator. Immediately following sonication, the sample is placed in a standard calibrated electrolytic conductivity cell (K=1). A Fisher Scientific AB 30 conductivity meter is introduced to the sample to measure the conductivity of the sample. The conductivity is plotted over the course of about 40 minutes.

The graphenic carbon particles may be substantially free of unwanted or deleterious materials. For example, the graphenic carbon particles may contain zero or only trace amounts of polycyclic aromatic hydrocarbons (PAHs), e.g., less than 2 weight percent PAH, less than 1 weight percent PAH, or zero PAH.

Starting graphenic carbon nanoparticles can be made, for example, by thermal processes. Thermally produced graphenic carbon particles may be made from carbon-containing precursor materials that are heated to high temperatures in a thermal zone such as a plasma. The carbon-containing precursor, such as a hydrocarbon provided in gaseous or liquid form, is heated in the thermal zone to produce the graphenic carbon particles in the thermal zone or downstream therefrom. For example, thermally produced graphenic carbon particles may be made by the systems and methods disclosed in U.S. Pat. Nos. 8,486,363, 8,486,364 and 9,221,688.

The graphenic carbon particles may be made by using the apparatus and method described in U.S. Pat. No. 8,486,363 in which (i) one or more hydrocarbon precursor materials capable of forming a two-carbon fragment species (such as n-propanol, ethane, ethylene, acetylene, vinyl chloride, 1,2-dichloroethane, allyl alcohol, propionaldehyde, and/or vinyl bromide) is introduced into a thermal zone (such as a plasma), and (ii) the hydrocarbon is heated in the thermal zone to a temperature of at least 1,000° C. to form the graphenic carbon particles. The graphenic carbon particles may be made by using the apparatus and method described in U.S. Pat. No. 8,486,364 in which (i) a methane precursor material (such as a material comprising at least 50 percent methane, or, in some cases, gaseous or liquid methane of at least 95 or 99 percent purity or higher) is introduced into a thermal zone (such as a plasma), and (ii) the methane precursor is heated in the thermal zone to form the graphenic carbon particles. Such methods can produce graphenic carbon particles having at least some, in some cases all, of the characteristics described above.

During production of the graphenic carbon particles by the thermal production methods described above, a carbon-containing precursor is provided as a feed material that may be contacted with an inert carrier gas. The carbon-containing precursor material may be heated in a thermal zone, for example, by a plasma system such as a DC plasma, RF plasma, microwave plasma, etc. The precursor material may be heated to a temperature ranging from greater than 2,000° C. to 20,000° C. or more, such as 3,000° C. to 15,000° C. For example, the temperature of the thermal zone may range from 3,500 to 12,000° C., such as from 4,000 to 10,000° C. Although the thermal zone may be generated by a plasma system, it is to be understood that any other suitable heating system may be used to create the thermal zone, such as various types of furnaces including electrically heated tube furnaces and the like.

The gaseous stream may be contacted with one or more quench streams that are injected into the plasma chamber through at least one quench stream injection port. The quench stream may cool the gaseous stream to facilitate the formation or control the particle size or morphology of the graphenic carbon particles. After contacting the gaseous product stream with the quench streams, the ultrafine particles may be passed through a converging member. After the graphenic carbon particles exit the plasma system, they may be collected. Any suitable means may be used to separate the graphenic carbon particles from the gas flow, such as, for example, a bag filter, cyclone separator or deposition on a substrate.

Without being bound by any theory, it is currently believed that the foregoing methods of manufacturing graphenic carbon nanoparticles are particularly suitable for producing graphenic carbon nanoparticles having relatively low thickness and relatively high aspect ratio in combination with relatively low oxygen content, as described above. Moreover, such methods are currently believed to produce a substantial amount of graphenic carbon nanoparticles having a substantially curved, curled, creased or buckled morphology (referred to herein as a “3D” morphology), as opposed to producing predominantly particles having a substantially two-dimensional (or flat) morphology. This characteristic is believed to be reflected in the previously described compressed density characteristics and is believed to be beneficial because, it is currently believed, when a significant portion of the graphenic carbon particles have a 3D morphology, “edge to edge” and “edge-to-face” contact between graphenic carbon particles within the composition may be promoted. This is thought to be because particles having a 3D morphology are less likely to be aggregated in the composition (due to lower Van der Waals forces) than particles having a two-dimensional morphology. Moreover, it is currently believed that even in the case of “face to face” contact between the particles having a 3D morphology, since the particles may have more than one facial plane, the entire particle surface is not engaged in a single “face to face” interaction with another single particle, but instead can participate in interactions with other particles, including other “face to face” interactions, in other planes. As a result. graphenic carbon particles having a 3D morphology may provide good electrically and/or thermally conductive pathways in the active composite particles and may be useful for obtaining electrical and/or thermal conductivity characteristics in the coatings.

Binders that may be used in the supercapacitor electrode coatings include polymers such as poly(vinyl ester), poly(vinyl alcohol), poly(vinyl acetal), poly(vinyl ether), poly(N-vinyl amide), poly(N-vinyl lactam), poly(N-vinyl amine) and copolymers thereof. Examples of poly(vinyl ester) include poly(vinyl acetate), poly(vinyl benzoate), poly(vinyl propionate), poly(vinyl pivalate), poly(vinyl 2-ethylhexanoate), poly(vinyl neodecanoate), and poly(vinyl neononanoate) and copolymers thereof. Examples of poly(vinyl ether) include poly(methyl vinyl ether), poly(ethyl vinyl ether), poly(butyl vinyl ether), poly(isobutyl vinyl ether), poly(cyclohexyl vinyl ether), poly(phenyl vinyl ether), and poly(benzyl vinyl ether) and copolymers thereof. Examples of poly(N-vinyl amide) and poly(N-vinyl lactam) include poly(N-vinyl formamide), poly(N-vinyl acetamide), poly(N-vinyl-N-methyl acetamide), poly(N-vinyl phthalimide), poly(N-vinyl succinimide), poly(N-vinyl pyrrolidone), poly(N-vinyl piperidone), and poly(N-vinyl caprolactam) and copolymers thereof. Examples of poly(N-vinyl amine) include poly(N-vinyl imidazole) and poly(N-vinyl carbazole) and thereof. In addition to these vinyl monomers, other co-monomers can be used such as acrylate esters, methacrylate esters, unsaturated acids (acrylic acid, methacrylic acid), maleic anhydride, styrene and other vinyl aromatic monomers, acrylonitrile, methacrylonitrile, and olefins such as ethylene, propylene, butylene and longer chain alpha-olefins. Poly(vinyl alcohol) may be produced by saponification of a poly(vinyl ester) such as poly(vinyl acetate) and copolymers of poly(vinyl acetate). The poly(vinyl alcohol) groups can be further reacted with different aldehydes and ketones to produce poly(vinyl acetal) such as poly(vinyl butyral). Aldehydes that can be used are formaldehyde, acetaldehyde, propionaldehyde, butyraldehyde, isobutyraldehyde, pivaldehyde, glyoxylic acid, and benzaldehyde. Poly(vinyl butyral) is often a terpolymer comprising the residues of vinyl acetate, vinyl alcohol, and the cyclic butyral group. Characteristics of poly(vinyl butyral) and related poly(vinyl acetal)s include degree of acetalization, residual hydroxyl content, residual acetate content, and molecular weight. In addition, other polymers can include polysaccharides such as chitosan, chitin, sodium carboxymethyl cellulose, cellulose acetate, sodium alginate and the like. For example, the binder may comprise poly(vinyl butyral) or similar types of binders such as other poly(vinyl acetal), such as poly(vinyl formaldehyde), poly(vinyl acetaldehyde), poly(vinyl benzaldehyde), and optionally comprising any co-monomer listed above. When poly(vinyl butyral) or similar compositions are used as the binder, they may optionally be functionalized.

The functionalized poly(vinyl butyral) binder material may be made by processes such as reactions between residual hydroxyl functionality of poly(vinyl butyral) with electrophiles, such as carboxylic acids, acid anhydrides, or isocyanate functional materials. In the case of a reaction between the residual hydroxyl and cyclic acid anhydrides, a pendant carboxylic acid can be formed. Reactions such as these can be performed in solution and catalyzed using appropriate catalysts.

The functionalized poly(vinyl butyral) may possess the properties and characteristics which can be controlled by the reacted constituent. Due to the functionalization process, the base poly(vinyl butyral) polymer may be altered such that the molecular weight of the polymer is increased. Additionally, by changing the functionality, the thermal transitions of the material such as the glass transition temperature may be altered. Due to the functionalization process, hydroxyl equivalent weight often is decreased while the acid value may increase. As a result, functionalized poly(vinyl butyral) may also be more or less hydrophobic compared to the initial material depending on the added functionality. Also, due to the added functional groups, such as a carboxylic acid, the functionalized poly(vinyl butyral) can provide ionic interactions with other coating constituents.

When used in supercapacitor electrode coatings, the functionalized poly(vinyl butyral) binders may provide advantages including increased adhesion to the activated metal oxide/activated carbon particles, the carbon within the coating and/or the current collector, increased dispersibility of the materials within the coating during slurry preparation, and increased hydrophilicity.

The supercapacitor electrode coatings may be produced by combining or mixing separately produced metal oxide particles and carbon particles, or by producing one type of particles followed by production of the other type of particles. For example, as more fully described below, carbon particles such as graphenic carbon nanoparticles may initially be provided in an aqueous dispersion, followed by producing metal oxide particles such as manganese oxide in the aqueous dispersion containing the pre-formed graphenic carbon nanoparticles. Spray drying techniques may be used to produce the present active composite particles and/or coatings. Spray drying involves passing a solution or slurry through a small nozzle, which aerosolizes the solution or slurry through a hot gas. The hot gas is responsible for rapid drying of individual aerosolized particles with minimal residence time at high temperatures, removing the volatile solvent and creating a dried spherical-like particle of solid material composed of non-volatile materials from the original solution or slurry. The final dried particles are then collected. Slurries of activated metal oxide particle composites with carbon-based supports and polymeric materials may be sent through a spray-dry nozzle, aerosolized from the nozzle, rapidly dried by hot air, and collected. After completing spray drying of the slurries, the final active material powder may be collected for further processing into electrode coatings. Spray drying allows for the formation of relatively uniform particle sizes comprised of a substantially homogeneous mixture of activated metal oxide, carbon-based support, and polymeric materials, preventing the formation of activated metal oxide agglomerates typically observed in traditional oven drying. The lack of large agglomerations of activated metal oxide particles may be attributed to the rapid drying nature of spray drying, limiting time that is typically required for agglomerates of metal oxides to form and forcing them to dry as a homogeneous mixture with the carbon support and polymeric materials. For example, an aqueous solution comprising the activated metal oxide particles and carbon-containing support particles may be spray dried to produce the active composite particles.

The supercapacitor electrode coatings may be deposited onto various types of substrates used in supercapacitors. For example, the coatings may be deposited on current collector plates, foils, mesh, foams and the like. Suitable current collector substrates may be made from metals such as nickel, stainless steel (e.g., 316 stainless steel, 304 stainless steel), aluminum, copper and titanium, as well as other electrically conductive materials such as graphite, carbon fiber, and the like. Any suitable type of coating process may be used, such as spraying, rolling, brushing, additive manufacturing and the like.

When the coatings are formed by additive manufacturing processes, such processes may include any suitable process such as material jetting, binder jetting, directed energy deposition, material extrusion, sheet lamination, powder bed fusion, vat photopolymerization and the like. Material jetting is an additive manufacturing process in which droplets of feedstock material are selectively deposited. The feedstock material may be deposited layer by layer until a coating of desired thickness formed. Binder jetting is an additive manufacturing process in which a liquid bonding agent is selectively deposited to join powder materials. The powder material may be spread in a thin layer on a printing plate. Droplets of binder may be deposited into the powder bed to bond the powder at the location of the droplets. After a layer is completed, the printing plate may be dropped, and another layer of powder material may be spread across the printing plate. This process repeats until the coating is completed.

The supercapacitor electrode coatings may have controlled thicknesses, for example, greater than 20 microns, or greater than 50 microns, or greater than 70 microns. The electrode coatings may have thicknesses of up to 500 microns, for example, up to 350 microns, or up to 200 microns. Typical electrode coating thicknesses may range from 20 to 500 microns, for example, from 50 to 350 microns, or from 70 to 200 microns.

The supercapacitor electrode coating thicknesses may also be measured in terms of weight per unit surface area. The electrode coating thicknesses may typically be greater than 1 mg/cm², for example, greater than 3 mg/cm², or greater than 5 mg/cm². The electrode coating thicknesses may be up to 50 mg/cm², for example, up to 20 mg/cm², or up to 10 mg/cm². The electrode coating thickness may typically range from 1 to 50 mg/cm², or from 3 to 20 mg/cm², or from 5 to 10 mg/cm².

The supercapacitor electrode coatings may have controlled porosity, for example, a porosity of at least 20 volume percent or at least 40 volume percent, or at least 60 volume percent. Porosities of up to 90 volume percent, or up to 80 volume percent, or up to 75 volume percent may be provided. The porosity of the electrode coatings may typically range from 20 to 90 volume percent, for example, from 50 to 80 volume percent, or from 60 to 75 volume percent. Porosity may be measured by standard techniques known to those skilled in the art. For example, the relative densities of all components of the coating may be calculated, the total volume of the components may be determined by conventional imaging techniques using commercially available software, the total volume of the coating may be determined by measuring the thickness and other dimensions of the film coating, and the porosity, in volume percent, may be calculated therefrom.

The supercapacitor electrode coatings may have controlled microstructures due to controlled agglomeration of activated metal oxide particles, activated carbon particles, and polymeric dispersant such that even homogeneity of materials and microstructure may be achieved. The access of the particle surface to the electrolyte may be due to the space between MnO₂|GNP, binder, and CNTs in the particle, which may be present because the MnO₂|GNP were prevented from agglomerating with each other in a way that blocks access of the surfaces to the electrolyte. If MnO₂|GNP were to bind to another MnO₂|GNP particle through agglomeration, the surface that is in direct contact with another particle may not be available to electrolyte, lowering capacitance. The surfaces of the MnO₂|GNP particles may be inhibited from binding to each other through spray-drying, and instead may be fixed into positions such that the surfaces of the primary particles are more exposed to electrolyte within the secondary particle, allowing those surfaces more access to electrolyte.

The supercapacitor electrode coatings may comprise substantially uniform distributions of the active composite particles and/or conductive carbon-containing particles, e.g., throughout the thicknesses of the coatings. Alternatively, the active composite particles and/or conducted carbon-containing particles may be non-uniformly distributed throughout the thicknesses of the coatings in a graded structure. For example, the active composite particles and/or conductive carbon-containing particles may be provided in higher concentrations or loadings on or near the surfaces of the electrode coatings, or the conductive carbon-containing particles such as carbon black may be provided in higher concentrations on or near the bottom of the coating near the conductive substrate.

Prior to deposition of the supercapacitor electrode coatings onto substrates, the substrates may be pre-treated. For example, for cathode coatings, current collector substrates may be pre-treated by processes such as an acid treatment to remove oxide layers and application of an organic coating to improve supercapacitor electrode coating adhesion and to prevent oxidation or reduction electrochemical reactions to occur at current collector surfaces. The native oxide present on a metal current collector may be removed by soaking in an acidic solution, for example hydrochloric acid, hydrofluoric acid, or oxalic acid. pH values of these solutions may range from 0-4. Removal of current collector oxide layer may be accelerated via application of an electrochemical bias. For example, a 5 V electrochemical potential may be applied across a substrate submerged in an acid solution for 2 minutes.

Upon deoxidization of the metal substrate surface, an organic coating may be applied to the surface using wet application methods, such as a doctor blade drawdown. The organic coating formulation may contain a carbon material such as carbon black, graphite, or a combination of the two, blended with a fluoropolymer binder such as polyvinylidene difluoride, an acrylic polymer, and a melamine cross linker dispersed in an organic solvent. For example, the binder may comprise fluoropolymers and addition polymers as described in U.S. Application Publication No. US2020/0176777, paragraphs [0020]-[0023], [0037]-[0049], [0166] and [0173]. The carbon content typically ranges from 70 to 95 weight percent of the solids with the remainder being polyvinylidene difluoride and 0.5-2 weight percent melamine. These films may then be cured at 120° C. for 4 minutes. The pre-treatment coatings when applied to the deoxidized current collector typically range from 0.2 to 0.6 mg/cm² and may be used without further processing.

When the activated metal oxide particles and activated carbon particles are combined together in a rapid-drying process, a slurry or suspension of activated metal oxide particles and activated carbon particles in a liquid carrier may be provided, which is rapidly dried to form a powder comprising composite particles of activated metal oxide and activated carbon. For example, each composite particle may comprise a combination of activated metal oxide particles and graphenic carbon nanosheets in which the activated metal oxide particles contact each other to form a continuous or interconnected network of activated metal oxide particles, and the graphenic carbon nanosheets are distributed throughout the composite particle. Alternatively, the graphenic carbon nanosheets may contact each other to form a continuous or interconnected network of graphenic carbon within the composite particles. Each composite particle may thus comprise multiple activated metal oxide particles and multiple graphenic carbon nanosheets adjacent, adhered or agglomerated together to form the composite particle. In such agglomerated composite particles, the activated metal oxide particles and graphenic carbon nanosheets may be uniformly distributed throughout each particle, or non-uniformly distributed.

The following examples are for illustration purposes, which, however, are not to be considered as limiting.

### EXAMPLES

### Formulation of Aqueous Graphene Dispersion

A 1500 g aqueous dispersion of graphenic carbon particles at a total-solids loading between 3-6 weight percent depending on the formulation is prepared, using a pigment-to-dispersant ratio of 14/1. Graphenic carbon sources included thermally produced graphenic carbon nanoparticles sold under the name Raymor PureWave graphene nanoplatelets and XG Sciences M25 exfoliated graphite graphene nanoplatelets. The dispersant is typically polyvinyl pyrrolidone at a molecular weight near 1.3 MDa. The dispersions are first mixed in the appropriate amount of water with a Cowles blade between 500-1000 rpm for approximately 60 minutes before transferring to an Eiger mill with a 250 mL milling chamber volume. The milling media size used during the milling step is approximately 1.0 mm (Zamil Y) and is added to the milling chamber to take up approximately 80% of the total volume. Dispersions are milled at 2000 rpm at a residence time of 15 minutes.

TABLE 1
Particle size distribution of various graphene
dispersions in aqueous solution with a P:B = 14

Particle size distribution (μm)

| Graphene Dispersion Sample | D10 | D50 | D90 |
|---|---|---|---|
| PureWave only 3 wt-% | 3.5 | 6.4 | 12.1 |
| 1:1 PureWave/M25 3 wt-% | 3.9 | 17.1 | 37.0 |
| 1:3 PureWave/M25 3 wt-% | 2.7 | 10.9 | 20.7 |
| M25 only 3 wt-% | 5.8 | 24.3 | 60.0 |
| 1:3 PureWave/M25 6 wt-% | 3.6 | 21.7 | 57.5 |

Particle size collected using a Mastersizer 2000 with a Hydro 2000S(A) accessory using the general purpose (spherical) analysis model.

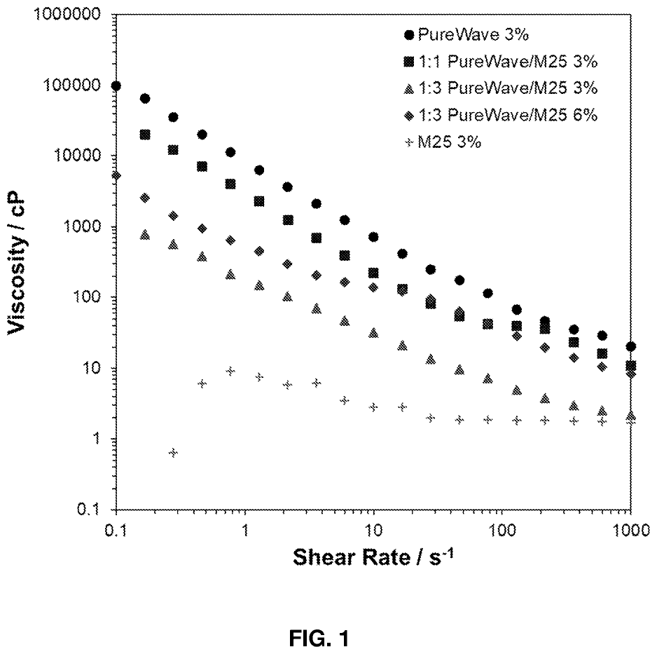

Rheological profiles of the dispersions listed in Table 1 are provided in FIG. 1. FIG. 1 includes rheological profiles of 3 weight percent aqueous graphene dispersions of (•) Raymor PureWave graphene, (+) XG Sciences M25 graphene, a (▪) 1:1 and (▴) 1:3 weight-ratio of Raymor PureWave graphene and XG Sciences M25 graphene, as well as (♦) a 6 weight percent aqueous dispersion of 1:3 Raymor PureWave graphene and XG Sciences M25 graphene.

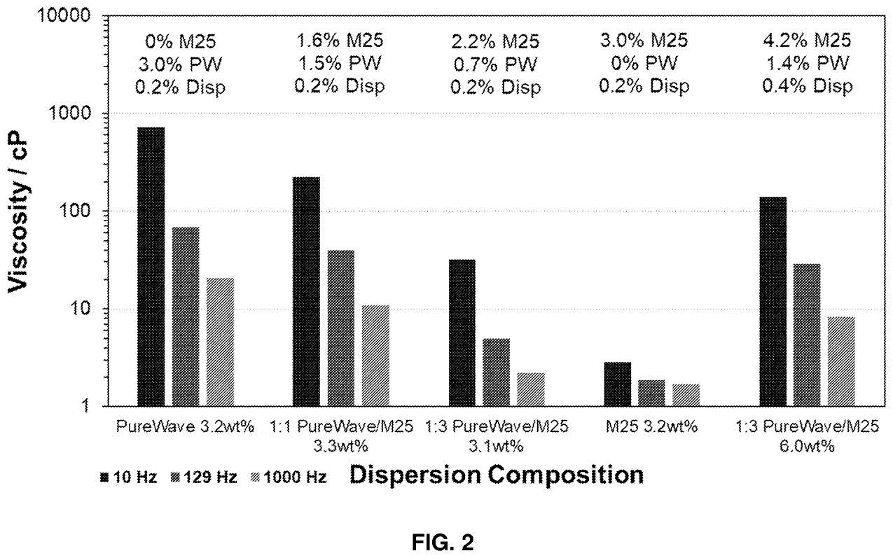

Viscosity measurements of the dispersions listed in Table 1 are provided in FIG. 2. FIG. 2 includes viscosity measurements of aqueous dispersions containing various quantities of XG Sciences M25 exfoliated graphite graphenic carbon, Raymor PureWave graphenic carbon, and dispersant at either 3 weight percent or 6 weight percent total solids.

The rheological profiles shown in FIG. 1 and the viscosity measurements shown in FIG. 2 are measured by standard procedures, using an Anton Paar MCR 302 and CP50-1 TG measuring cone. Viscosity measurements at a shear rate of 10 Hz may be used for comparison of dispersion rheologies.

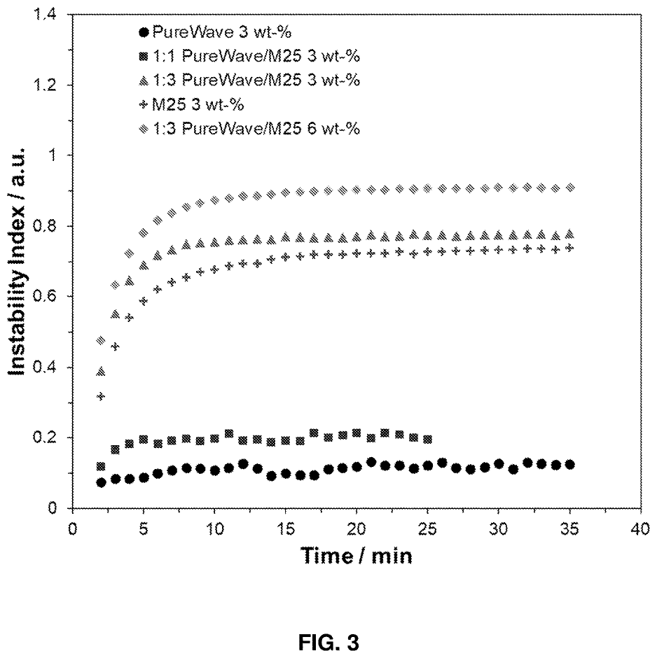

Instability index plots of the dispersions listed in Table 1 are provided in FIG. 3. The instability index properties are measured as described above. FIG. 3 includes instability indexes of 3 weight percent aqueous graphene dispersions containing (•) Raymor PureWave graphene, (+) XG Sciences M25 graphene, a blend of (▪) 1:1 and (▴) 1:3 weight-ratio of Raymor PureWave graphene and XG Sciences M25 graphene, as well as (♦) a 6 weight percent aqueous dispersion of 1:3 Raymor PureWave graphene and XG Sciences M25 graphene. The instability index is measured by the procedure described below.

Instability index analysis may be used for accelerated evaluation of long-term stability, which measures dispersion sedimentation at specified centrifuging speeds and temperatures. Unless otherwise indicated in the specification or claims, the “instability index” is measured as follows: dispersion samples are loaded in a centrifuge and pulsed near IR light at 865 nm is transmitted through the samples. During centrifuging, the near IR light transmitted through the samples is measured with a dispersion analyzer sold under the designation LUMiSizer Model 611 by LuM GmbH. The measurement is made at 25° C. and 4000 rpm centrifuge speed with a relative centrifugal acceleration (RCA) of 2202 during approximately 20 to 35 minutes of centrifuging. The transmission level at the beginning of the centrifuging is compared with the transmission level at the end of the 20 minute period, and the instability index is calculated by normalizing the recorded change in transmission levels. The instability index reported is a dimensionless number between 0 and 1, with “0” meaning no changes of particle concentration and “1” meaning that a dispersion has completely phase separated. A relatively unstable dispersion will exhibit a higher increase in transmission due to significant phase separation of the graphenic carbon nanoparticles and solvent, while a relatively stable dispersion will exhibit a lower increase in transmission due to less phase separation. The instability index may be calculated using the SEPView® software tool. A description of how the SEPView® software tool determines the instability index is provided in the article entitled “Instability Index” (T. Detloff, T. Sobisch, D. Lerche, Instability Index, Dispersion Letters Technical, T4 (2013) 1-4, Update 2014), which is incorporated herein by reference. The instability index of aqueous dispersions of graphenic carbon nanoparticles may typically be less than 0.7, for example, less than 0.6, or less than 0.5, or less than 0.4, or less than 0.3, or less than 0.1.

FIGS. 1-3 demonstrate rheological changes observed when an expanded or exfoliated graphite graphene particle is dispersed alongside turbostratic, thermally produced graphenic carbon particles, and the resulting increased stability achieved of the graphenic carbon in solution when a 1:1 w/w ratio of expanded graphite graphene and turbostratic, thermally produced graphenic carbon particles are used in solution prior to using the particles as a conductive support for the growth of an activated metal oxide such as manganese dioxide. Synthesis of MnO₂|GNP

Potassium permanganate (182.7 g, 1.16 moles) is dissolved in 2818 g of deionized water. Separately, benzyl alcohol (375.1 g, 3.47 moles) is added to a 500 mL addition funnel and equipped onto a 5 L multineck flask. An aqueous-based graphene dispersion (3 weight percent graphene, total graphene/polyvinylpyrrolidone dispersant ratio was 14:1) is charged to the 5 L multineck round bottom flask (374 g total dispersion, 11.97 g of total solid material) and stirred with a Teflon® stir blade equipped onto an air motor spinning between 100-500 rpm. The speed of the stir blade can be adjusted as necessary during the reaction between 100-1000 rpm to maintain adequate cooling and dispersion of the material. The flask is then placed in an ice bath, and the addition of benzyl alcohol begins at a rate of approximately 6 mL/min for 5 minutes. Then, addition of potassium permanganate begins at a rate of approximately 50 mL/min using a peristaltic pump and silicone tubing. Nitrogen gas is charged into the reaction flask throughout the experiment to aid in cooling and remove oxygen from the reaction atmosphere. The reaction temperature is maintained at approximately 15-25° C. throughout the entire reaction. The reagents take approximately 1 hour to fully add to the flask, after which the reaction is allowed to continue stirring at approximately room temperature for an additional hour to ensure a full reaction. The final reaction is then filtered and washed with DI water and isopropanol, followed by a final rinse of DI water before the hydrated product is collected. The powder is measured for total solids content to deternine level of hydration. In some examples, the intermediate powder is dried under vacuum at 100° C. for at least 4-6 hours.

Following collection of the product of potassium permanganate reduction, a portion of the powder is resuspended in an aqueous solution containing poly(acrylic acid) (Sigma Aldrich, 450 kg/mol), neutralized to pH 7 with potassium hydroxide (denoted as KPAA), and carbon nanotubes (C-Nano LB217-54, denoted as CNTs) to yield a total solids dispersion of approximately 34 weight percent. This weight-percent can be adjusted as necessary to accommodate for changes in viscosity to ensure adequate mixing of the materials, from 5-40 weight percent. This solution of KPAA and CNTs is made prior to addition of the powder. For example, 11.6 g of a 13 weight percent solution of KPAA is charged into a small plastic container with lid, along with 20.0 g of a 6.25 weight percent CNT dispersion containing 5 weight percent CNTs (1.25 weight percent dispersant). This solution is thoroughly mixed in a small planetary THINKY mixer at 2000 rpm for approximately 2-5 minutes. This solution is then transferred to a larger plastic container with an appropriately sized Cowles blade mixer, and 264 g of the MnO₂|GNP hydrated powder is incorporated (powder was measured to be 37 weight percent solids, 63% water). Additional deionized water is added if necessary to ensure a shear-thinning, relatively high-viscosity slurry stirring between 1000-1500 rpm. The solution is allowed to mix for 1 hour before reducing the stir speed to between 250-750 rpm, when the solution is diluted with 704 g of deionized water. The solution is allowed to stir for an additional 1 hour at 250-750 rpm. If needed, horn sonication is also applied to the dispersion for 1 hour (Branson Sonifier® 550) at 80% power, cooling with an ice bath. Prior to the next step, 0.4 g of a solution of carbodiimide cross-linker (40 weight percent, Carbodilite V-02-L2) is prepared and allowed to stir for at least 10-20 minutes.

The above solution is then spray-dried with a mini spray-drier (Buchi) with inlet temperature set to 220° C., aspirator setting set to 60%, and a pump speed of 18-26% to control the outlet temperature at approximately 90-95° C. In some examples, the resulting powder is further dried under vacuum at 150° C. for at least 4-6 hours.

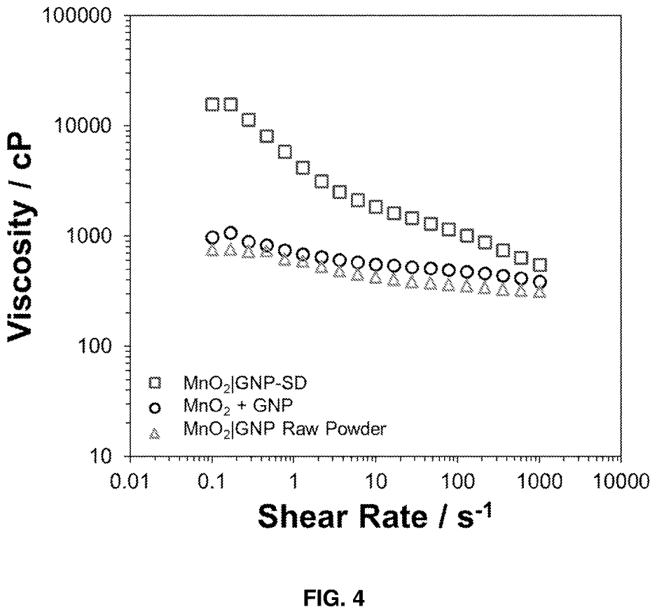

FIG. 4 includes rheological data, measured as described above, for dispersions containing approximately equal concentrations of MnO₂, graphene, conductive carbon, and binder, with (O) commercial activated MnO₂ physically mixed with a 1:1 w/w ratio of PureWave graphene and M25 graphene, (Δ) MnO₂ synthetically grown in the presence of a 1:1 w/w ratio of PureWave graphene and M25 graphene that is dried at 100° C. under vacuum for at least 4 hours, and (□) MnO₂ synthetically grown in the presence of a 1:1 w/w ratio of PureWave graphene and M25 graphene that is formulated with an acrylic binder and carbon nanotubes prior to spray-drying. All samples contain approximately 69-71 weight percent MnO₂, 7-8 weight percent graphene, 10-11 weight percent of binder comprising of a 4:1 w/w ratio of PVBA and PVP, and approximately 10-12 weight percent of a conductive carbon black such as Super P. The solvent is butyl cellosolve, and all slurries have a total solids content of 33.5 weight percent.

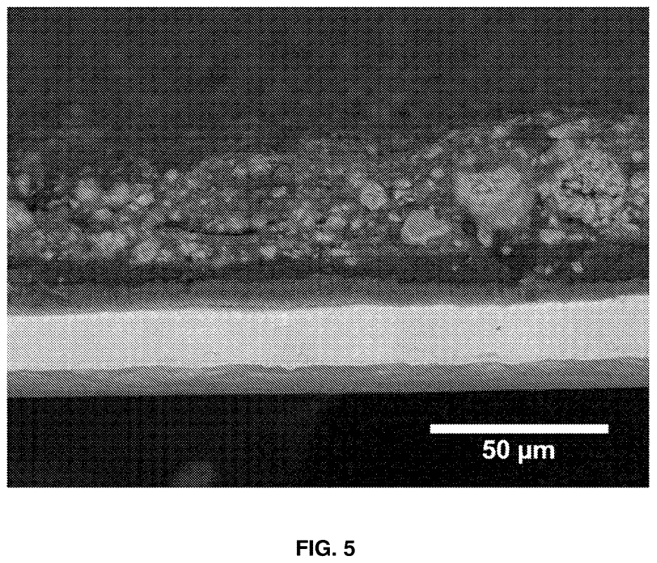

FIG. 5 is a cross-sectional scanning electron microscope image of MnO₂+GNP cathode coating on a carbon-coated Ni foil. The carbon coating contains both Super P and graphite at the Ni interface.

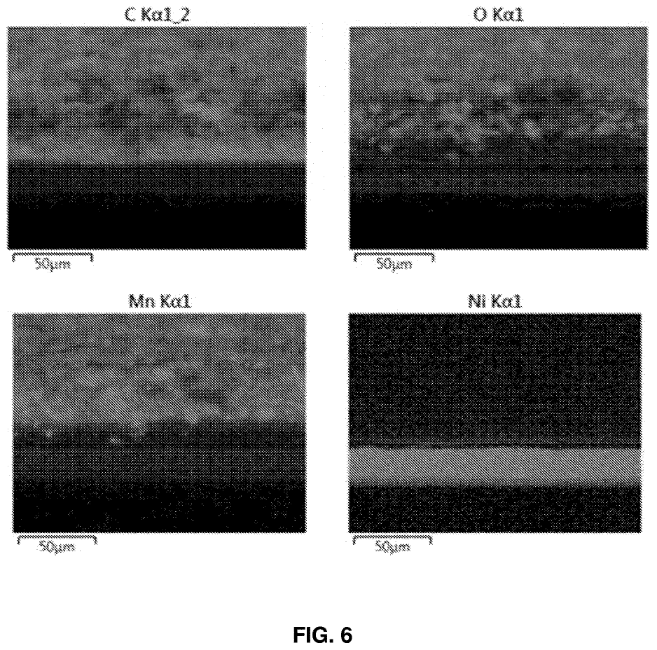

FIG. 6 is a cross-sectional scanning electron microscope electron dispersive spectroscopy (SEM-EDS) mapping of a MnO₂+GNP cathode coating on carbon-coated Ni foil, highlighting the inhomogeneous dispersion of (top left) carbon, (top right) oxygen, (bottom left) manganese, and (bottom right) nickel.

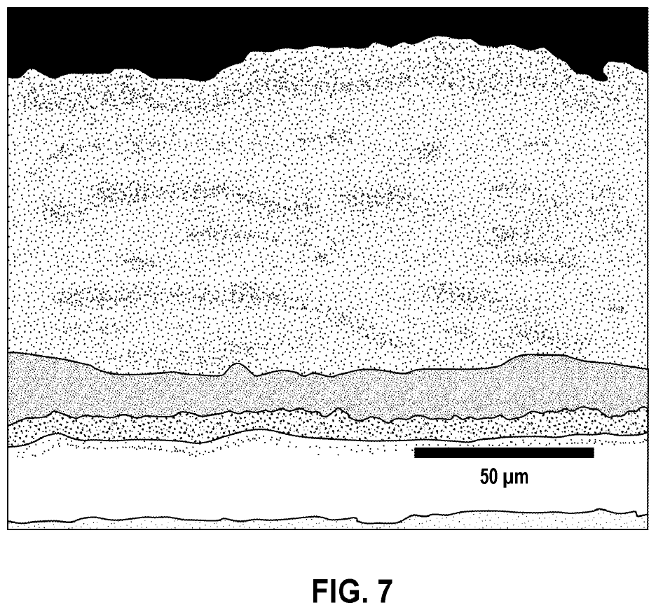

FIG. 7 is a cross-sectional scanning electron microscope image of MnO₂|GNP (not spray-dried) cathode coating on a carbon-coated Ni foil. The carbon coating contains both Super P and graphite at the Ni interface.

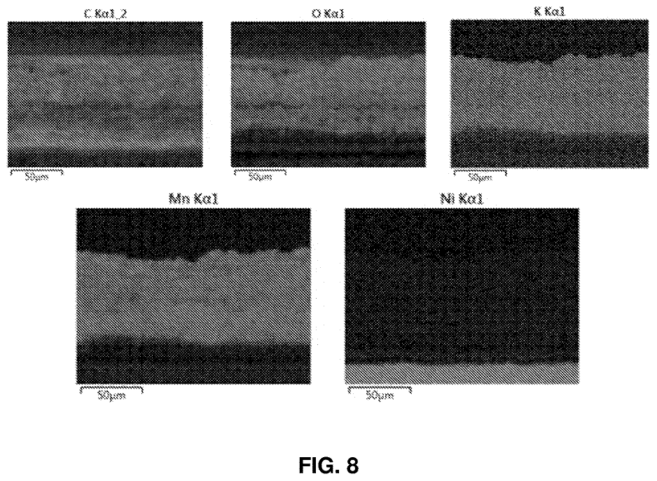

FIG. 8 is a cross-sectional scanning electron microscope electron dispersive spectroscopy (SEM-EDS) mapping of a MnO₂|GNP (not spray-dried) cathode coating on carbon-coated Ni foil, highlighting the dispersion of (top left) carbon, (top middle) oxygen, (top right) potassium, (bottom left) manganese, and (bottom right) nickel.

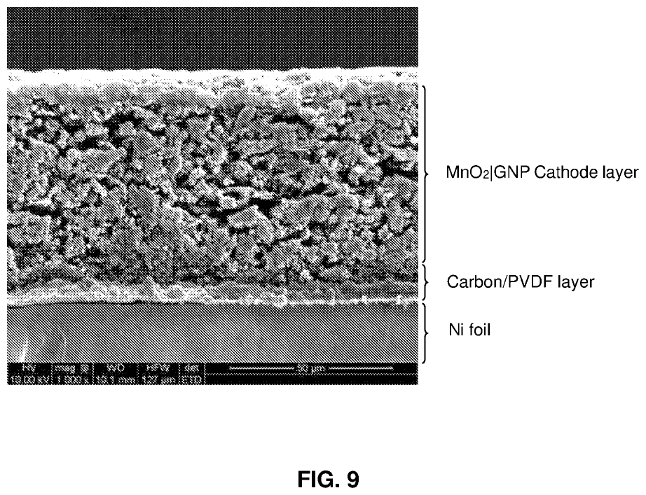

FIG. 9 is a cross-sectional scanning electron microscope image of spray-dried MnO₂|GNP cathode coating on a carbon-coated Ni foil. The carbon coating contains both Super P and graphite at the Ni interface.

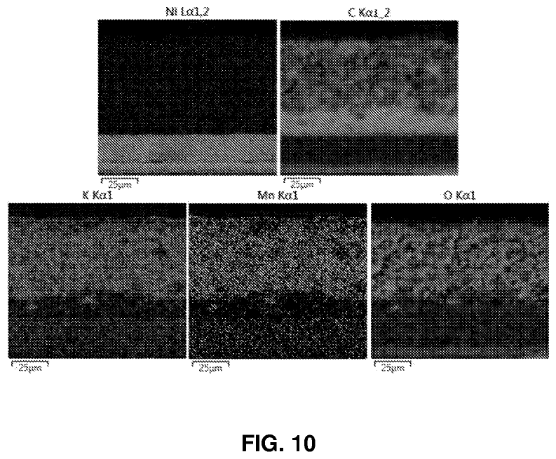

FIG. 10 is a cross-sectional scanning electron microscope electron dispersive spectroscopy (SEM-EDS) mapping of a spray-dried MnO₂|GNP cathode coating on carbon-coated Ni foil, highlighting the homogeneous dispersion of (top left) nickel, (top right) carbon, (bottom left) potassium. (bottom middle) manganese, and (bottom right) oxygen.

TABLE 2
ICP results highlighting metal content of each MnO₂|GNP
active material containing various graphene sources.

| | Wt-% | | |
|---|---|---|---|
| Element | PureWave | PureWave + M25 | M25 |
| Mn | 45.6% | 48% | 45.9% |
| K | 12.9% | 14 | 14.5% |
| Zr | 0.48% | 0.18% | 0.40% |

### Cathode Binder No. 1

In a four neck round bottom flask, 120 grams of poly(vinyl butyral-co-vinyl alcohol-co-vinyl acetate) [Mw 90,000-120,000][88 weight percent butyral, 11 weight percent hydroxyl, 1 weight percent acetate], 360 grams of 2-butoxyethanol acetate, 27 grams of succinic anhydride, and 0.15 grams of 1,4-diazabicyclo[2.2.2]octane are added and the flask is set up with a mechanical stir blade, thermocouple, and reflux condenser. The flask is heated to a set point of 100° C. under a nitrogen atmosphere. The reaction is then held at 100° C. for 4 hours. Subsequently the reaction temperature is increased to 120° C. for 4 hours. After this hold, the reaction is cooled and poured into a suitable container. The final measured solids of the resin is determined to be 30.4% solids.

### Cathode Binder No. 2

In a four neck round bottom flask, 104 grams of Mowital B30-T, 312.5 grams of 2-butoxyethanol acetate, 30 grams of succinic anhydride, and 0.13 grams of 1,4-diazabicyclo[2.2.2]octane are added and the flask is set up with a mechanical stir blade, thermocouple, and reflux condenser. The flask is heated to a set point of 120° C. under a nitrogen atmosphere. The reaction is then held at 120° C. for 8 hours. Subsequently the reaction temperature is decreased to 90° C. and 223 grams of 2-butoxyethanol is added to the flask. The reaction mixture is stirred for 2 hours. After this hold, the reaction is cooled and poured into a suitable container. The final measured solids of the resin is determined to be 18.4% solids.

### Cathode Binder No. 3

In a four neck round bottom flask, 92.4 grams of Mowital B30-T, 462 grams of 2-butoxyethanol acetate, 48 grams of succinic anhydride, and 0.12 grams of 1,4-diazabicyclo[2.2.2]octane are added and the flask is set up with a mechanical stir blade, thermocouple, and reflux condenser. The flask is heated to a set point of 100° C. under a nitrogen atmosphere. The reaction is then held at 100° C. for 6 hours. Subsequently the reaction temperature is decreased to 90° C. and 224 grams of 2-butoxyethanol is added to the flask. The reaction mixture is stirred for 30 minutes. After this hold, the reaction is cooled and poured into a suitable container. The final measured solids of the resin is determined to be 16.5% solids.

### Cathode Binder No. 4

In a four neck round bottom flask, 120 grams of poly(vinyl butyral-co-vinyl alcohol-co-vinyl acetate) [Mw 90,000-120,000][88 weight percent butyral, 11 weight percent hydroxyl, 1 weight percent acetate], 360 grams of 2-butoxyethanol acetate, 27 grams of succinic anhydride, and 0.15 grams of 1,4-diazabicyclo[2.2.2]octane are added and the flask is set up with a mechanical stir blade, thermocouple, and reflux condenser. The flask is heated to a set point of 100° C. under a nitrogen atmosphere. The reaction is then held at 100° C. for 8 hours. Subsequently 81.5 grams of 2-butoxyethanol is added to the flask. The reaction mixture is stirred for 15 minutes. After this hold, the reaction is cooled and poured into a suitable container. The final measured solids of the resin is determined to be 24.6% solids.

### Carbon Pre-Treatment Formulation

5.2 g of Timcal graphite and carbon super P conductive carbon black (MTI) is added to 37.15 g of a triethyl phosphate solution containing 2 weight percent of a mixture of PVDF and acrylic copolymers. This dispersion is hand mixed for 30 seconds prior to mixing in a centrifugal mixer at 2000 rpm for 2-minute intervals for a total of 6 minutes. After the carbon is fully dispersed, 0.4 g of a triethyl phosphate solution containing 10 weight percent melamine formaldehyde cross linker is added and mixed in a centrifugal mixer at 2000 rpm for 15 seconds. This carbon dispersion is coated onto Ni foil using a 5-mil drawdown bar, followed by curing at 150° C. for 10 minutes for a loading of 0.7 mg cm⁻².

### MnO₂|GNP Cathode Electrode Formulation-80/10/10 “Active”/Conductive Carbon/Binder

Samples not containing spray-dried MnO₂|GNP, 15 5-mm yttrium-infused zirconia milling beads are added to the mixer to ensure proper breakdown of particles. 0.67 g of carbon super P conductive carbon black (MTI) is added to 5.26 g of butyl cellosolve and 1.26 g of a butyl cellosolve solution containing 11 weight percent polyvinylpyrrolidone (1.3 MDa, Aldrich). This dispersion is mixed in a centrifugal mixer at 2000 rpm for 2-minute intervals for a total of 4 minutes or until fully dispersed. After mixing, the black dispersion is diluted with 5.26 g and mixed in a centrifugal mixer at 2000 rpm for 2 minutes. After dilution, 2.18 g of a butyl cellosolve acetate/butyl cellosolve solution containing 25 weight percent of an acid-functionalized polyvinylbutyral copolymer resin (PVBA) is added and mixed in centrifugal mixer at 2000 rpm for 2 minutes. Once fully dispersed, 5.36 g of MnO₂|GNP is added, and the final slurry is mixed in centrifugal mixer at 2000 rpm for 2 minute intervals for a total of 6 minutes or until fully dispersed. In the case of commercial MnO₂ or synthesized MnO₂|GNP that is not spray-dried, the milling time is stopped after 12 total minutes of milling. The final dispersion is coated onto carbon pre-treated Ni foil (25 m Ni foil with approximately 15-20 μm thick layer of carbon pretreatment at 0.7 mg cm⁻² loading) using a range of drawdown bar thicknesses between 5-10 mils, preferably 6-8 mils, following by curing at 55° C. and 120° C. for two minutes at each temperature. The final cured film is then calendared to the desirable porosity, typically from 60 to 75 volume percent.

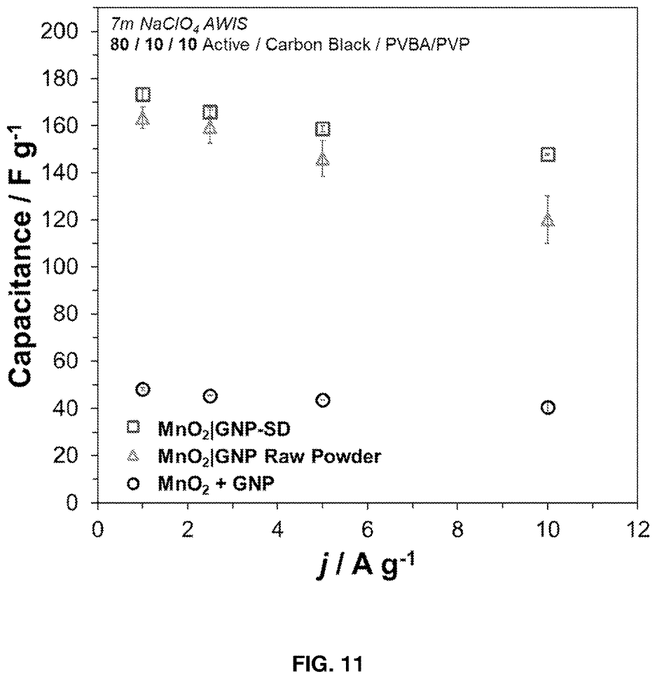

FIG. 11 includes capacitance vs current density (j) plots for 1.27 cm² electrodes of active material comprising (o) commercial manganese(IV) oxide mixed with a 1:1 w/w blend of PureWave and XG Sciences graphene at a weight ratio of 9:1 MnO₂:graphene, (Δ) MnO₂|GNP raw powder that was not blended with CNTs or KPAA and not spray-dried, and (□) MnO₂|GNP spray-dried with CNTs and KPAA. The coating formulation was 80/10/10 “active”: carbon black:binder. The binder in this system was PVBA/PVP at a 4:1 w/w ratio, and the carbon black source was Super P. The final film porosity, after calendaring, was measured to be approximately 73 volume percent. Each electrochemical cell was cycled between 0 and 1.25 V vs Ag/AgCl with a Pt mesh counter electrode and Ag/AgCl (sat'd KCl) reference electrode.

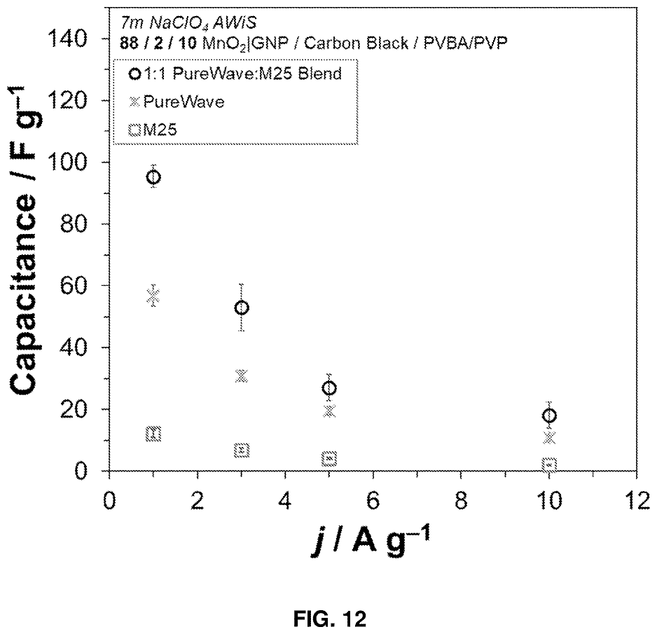

FIG. 12 includes capacitance vs current density (j) plots for 1.27 cm² electrodes of MnO₂|GNP with a formulation of 88/2/10 active/carbon black/binder, where the graphene used in the active material was estimated to be a 9:1 w/w ratio of MnO₂ and a graphene source of either PureWave graphene, XG Sciences M25 graphene, or a 1:1 w/w ratio of PureWave and M25 graphene. The binder in this system was PVBA/PVP at a 4:1 w/w ratio, and the carbon black source was Super P. Each electrochemical cell was cycled between 0 and 1.25 V vs Ag/AgCl with a Pt mesh counter electrode and Ag/AgCl (sat'd KCl) reference electrode.

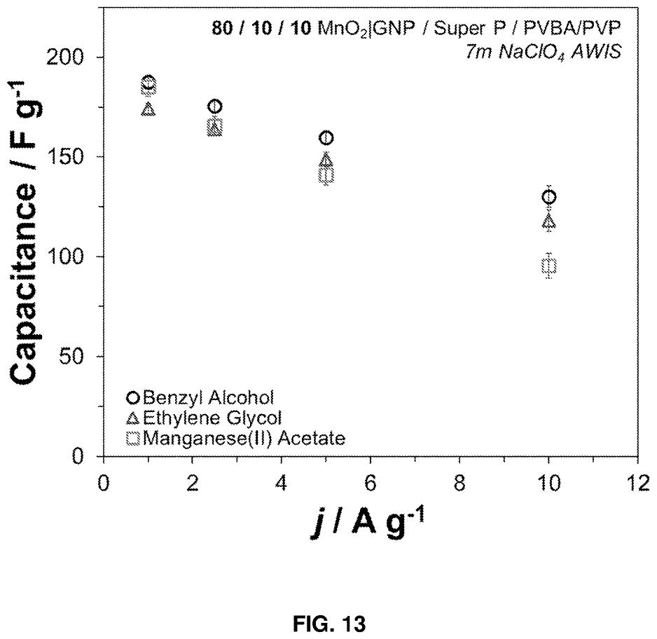

FIG. 13 includes capacitance vs current density (j) plots for 1.27 cm³ electrodes of MnO₂|GNP synthesized using (black, open circle) benzyl alcohol, (dark grey, triangle) ethylene glycol, or (light grey, square) manganese(II) acetate as the reducing agent to potassium permanganate in solution, followed by spray-drying with potassiated poly(acrylic acid) and carbon nanotubes. Coatings are made with an 80/10/10 active material/carbon black/binder formulation using Super P as the carbon black source and PVBA/PVP (4:1 w/w) as the binder.

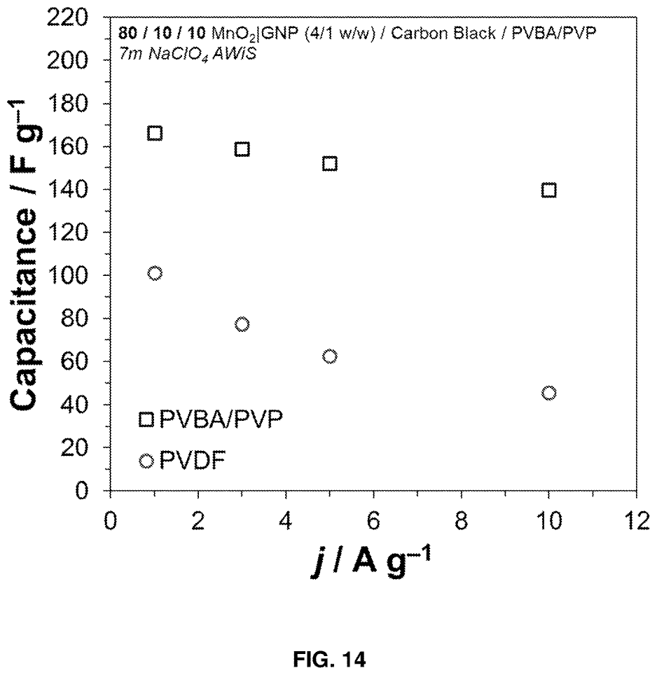

FIG. 14 includes capacitance vs current density (j) plots for 1.27 cm² electrodes of MnO₂|GNP with a formulation of 80/10/10 active/carbon black/binder, where the graphene used in the active material was estimated to be a 4:1 w/w ratio of MnO₂ and a graphene source of PureWave graphene. The binder in this system was PVBA/PVP at a 4:1 w/w ratio, and the carbon black source was Super P. Each electrochemical cell was cycled between 0 and 1.25 V vs Ag/AgCl with a Pt mesh counter electrode and Ag/AgCl (sat'd KCl) reference electrode.

The data shown in FIGS. 11-14 is generated by testing the coatings in half-cell format with an Ag/AgCl (sat'd KCl) reference electrode and Pt mesh counter-electrode in 7 m NaClO₄ acetonitrile/water-in-salt (AWiS) electrolyte. Cells are charged at a constant current between 1-10 A/g, then allowed to rest for 1 minute before discharging symmetrically to the charge rate and allowed to rest for 10 minutes. The charge passed during discharge is divided by the change in voltage of the discharge.

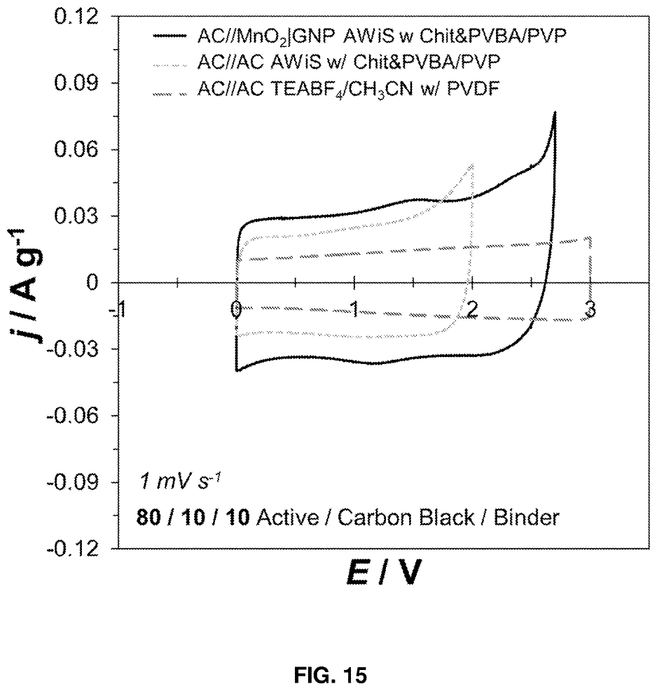

FIG. 15 includes cyclic voltammetry of full cells using 80/10/10 active material/carbon black/binder formulation with (dark grey, dashed) YP-80F activated carbon symmetrical electrodes on Al foil using PVDF as a binder in 1M TEABF₄ in acetonitrile, (light grey, dotted) YP-80F activated carbon symmetrical electrodes in 7 molal NaCO₄ acetonitrile/water-in-salt electrolyte on bare Ni foil using chitosan as a binder on the anode, and on carbon-coated Ni foil on the cathode and PVBA/PVB (4:1 w/w) binder, and (black, solid) YP-80F/MnO₂|GNP asymmetrical electrodes in 7 molal NaClO₄ acetonitrile/water-in-salt (AWiS) electrolyte on bare Ni foil using YP-80F activated carbon as the active material and chitosan as a binder on the anode, and MnO₂|GNP as the active material on carbon-coated Ni foil on the cathode and PVBA binder. All systems use Super P as the conductive carbon black source. The data shown in FIG. 15 is generated by first assembling the relevant and charge-balanced anode and cathode electrodes into a 2032 stainless steel coin cell with a polyolefin-based separator and appropriate electrolytes (1M tetraethylammonium tetrafluoroborate in anhydrous acetonitrile or 7 molal sodium perchlorate acetonitrile/water-in-salt electrolyte). For cells tested using 1M TEABF4 in acetonitrile, all cells are properly dried and assembled under an Ar atmosphere in a glovebox. For cells tested with the acetonitirile/water-in-salt electrolyte, the electrolyte contains an acetonitrile/water mole-ratio of 2:3, and cells are prepared under ambient conditions. The voltage of these cells is then scanned through cyclic voltammetry at a rate of 1 mV/s until the desired voltage is reached using a Bio-Logic VSP potentiostat.

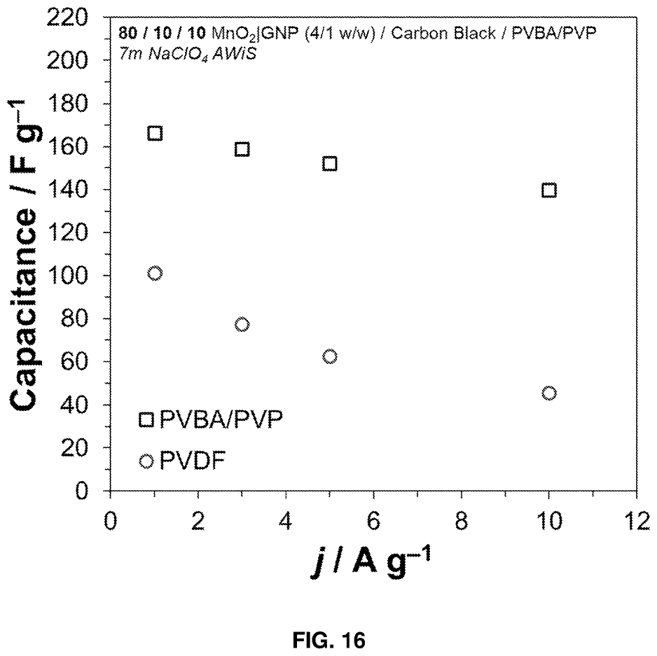

FIG. 16 includes capacitance vs current density (j) plots for 1.27 cm² electrodes of MnO₂|GNP with a formulation of 80/10/10 active/carbon black/binder, where the graphene used in the active material is estimated to be a 4:1 w/w ratio of MnO₂ and a graphene source of PureWave graphene. The binder in this system is PVBA/PVP at a 4:1 w/w ratio, and the carbon black source is Super P. Each electrochemical cell is cycled between 0 and 1.25 V vs Ag/AgCl with a Pt mesh counter electrode and Ag/AgCl (sat'd KCl) reference electrode. The data shown in FIG. 16, as well as in FIGS. 11-14, is generated by applying a constant current charge and discharge to a working electrode within a flooded-half-cell electrochemical cell at various current densities using a Bio-Logic VSP potentiostat. In all cases for half-cell testing described herein, the reference electrode is Ag/AgCl (saturated KCl), and the counter-electrode is Pt. The electrolyte used is 7 molal sodium perchlorate acetonitrile/water-in-salt electrolyte, AWiS, where the acetonitrile/water mole ratio is 2:3.

Devices incorporating the present electrode coatings may achieve capacitances of at least 100 F/g, for example, at least 140 F/g, or at least 150 F/g. Capacitances may range from 100 to 300 F/g, or from 140 to 250 F/g, or from 150 to 200 F/g. Current densities may range from 0.1 to 30 A/g, or from 0.5 to 20 A/g, or from 1 to 10 A/g, where the mass in grams refers to the mass of the active material on the electrode.

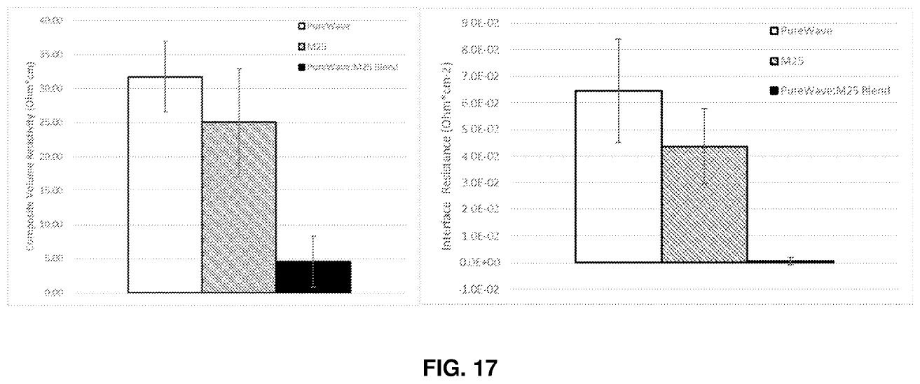

FIG. 17 includes (left) composite and (right) interfacial resistivity measurements of supercapacitor cathode coatings on Ni foil at an 88/2/10 formulation of MnO₂|GNP/Super P/Binder (modified polyvinyl butyral). Resistivity of the electrode coatings is measured using a HIOKI electrode resistance meter (HIOKI RM26111). Composite volume resistivity and interfacial contact resistivity are measured after calibrating the instrument with a gold coating (short) and bare plastic (open) plate provided by the manufacturer, and inputting the known resistivity of the metal current collector. The resistivity data is collected at three different areas of the electrodes and averaged for accuracy. Resistivity of the film can affect charge transport in the coating, with higher resistivity meaning poor conductivity and thus sluggish charge transport, and vice versa for lower resistivity. A better charge transport in electrode coatings (lower resistivity) enables power performance (fast charge-discharge) of the electrode.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth broad scope are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, unless indicated otherwise, a plural term can encompass its singular counterpart and vice versa, unless indicated otherwise. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect basic and novel characteristic(s)”.

As used herein, the terms “on,” “onto,” “applied on,” “applied onto,” “formed on,” “deposited on,” “deposited onto,” mean formed, overlaid, deposited, or provided on but not necessarily in contact with the surface. For example, an electrodepositable coating composition “deposited onto” a substrate does not preclude the presence of one or more other intervening coating layers of the same or different composition located between the electrodepositable coating composition and the substrate.

Whereas particular examples of this disclosure have been described above for purposes of illustration, it will be evident to those skilled in the art that numerous variations of the details of the present disclosure may be made without departing from what is defined in the appended claims.

1. A coating for use as a supercapacitor electrode, the coating comprising:
active composite particles comprising activated metal oxide particles and carbon-containing support particles; and
conductive carbon-containing particles.

2. The coating of claim 1, wherein the activated metal oxide particles are grown on the carbon-containing support particles.

3. The coating of claim 1, wherein the activated metal oxide particles comprise manganese oxide, potassium manganese oxide, sodium manganese oxide, lithium manganese oxide or combinations thereof.

4. (canceled)

5. The coating of claim 1, wherein the carbon-containing support particles comprise graphenic carbon nanoparticles.

6.-10. (canceled)

11. The coating of any claim 1, wherein the activated metal oxide particles comprise from 50 to 95 weight percent of the active composite particles.

12.-13. (canceled)

14. The coating of claim 1, wherein the carbon-containing support particles comprise from 5 to 50 weight percent of the active composite particles.

15. The coating of claim 1, wherein the conductive carbon-containing particles comprise carbon black, graphite, carbon nanotubes, graphene, activated carbon or a combination thereof.

16. (canceled)

17. The coating of claim 1, wherein the conductive carbon-containing particles are activated.

18. The coating of claim 1, wherein the active composite particles further comprise a composite binder.

19.-22. (canceled)

23. The coating of claim 1, wherein the active composite particles comprise from 60 to 98 weight percent of the coating.

24.-25. (canceled)

26. The coating of claim 1, wherein the active composite particles have an average particle size of from 100 nanometers to 100 microns.

27.-28. (canceled)

29. The coating of claim 1, wherein the conductive carbon-containing particles comprise from 1 to 30 weight percent of the coating.

30. The coating of claim 1, wherein the coating further comprises a binder.

31.-37. (canceled)

38. The coating of claim 1, wherein the conductive carbon-containing particles form an interconnected network in the coating.

39. The coating of claim 1, wherein at least a portion of the active composite particles are separate from each other in the coating.

40.-42. (canceled)

43. The coating of claim 1, wherein the coating has a thickness of from 20 to 500 microns.

44.-48. (canceled)

49. The coating of claim 1, wherein the coating has a porosity of from 20 to 90 volume percent.

50. Active composite particles for use in supercapacitor electrode coatings, the active composite particles comprising:
activated metal oxide particles; and
carbon-containing support particles, wherein the activated metal oxide particles are grown on the carbon-containing support particles.

51.-71. (canceled)

72. A method of making active composite particles for use in supercapacitor electrode coatings, the method comprising:
spray drying an aqueous solution comprising activated metal oxide particles and carbon-containing support particles; and
recovering the active composite particles comprising the activated metal oxide particles and the carbon-containing support particles.

73. A supercapacitor electrode comprising:
a current collector substrate; and
an electrode coating of claim 1 comprising:
active composite particles comprising activated metal oxide particles and carbon-containing support particles; and
conductive carbon-containing particles.

74.-82. (canceled)
